(19) United States
(12) Patent Application Publication
(10) Pub. No.: US 2014/0324529 A1
(43) Pub. Date: Oct. 30, 2014

(54) Method and System for Business Lead Generation and Auctioning

(71) Applicant: Derrick Bliss, West Babylon, NY (US)

(72) Inventor: Derrick Bliss, West Babylon, NY (US)

(21) Appl. No.: 14/261,491

(22) Filed: Apr. 25, 2014

Related U.S. Application Data
(60) Provisional application No. 61/816,277, filed on Apr. 26, 2013.

(51) Int. Cl. G06Q 30/08; G06Q 30/02

(52) U.S. Cl. CPC G06Q 30/08; G06Q 30/0201
USPC 705/7.29

(57) ABSTRACT

A computer-implemented method of business lead auctioning includes receiving a request for a service from a potential customer. The received request is matched with a plurality of service providers. The request and the plurality of service providers are matched according to a category of the service requested and a geographic area corresponding to the service. The matched plurality of service providers are notified that a virtual auction will be conducted for a business lead including vital contact information for the potential customer. A virtual auction for the business lead is generated. The virtual auction is conducted and one or more of the matched plurality of service providers bid for access to the vital contact information for the potential customer. The auction is closed and a winning service provider of the matched plurality of service providers is given the vital contact information for the potential customer.

### CROSS-REFERENCE TO RELATED APPLICATION

This application claims priority from U.S. Provisional Patent Application No. 61/816,277, filed Apr. 26, 2013, the entire contents of which are incorporated by reference herein.

### TECHNICAL FIELD

This invention relates generally to matching customers and businesses and, more particularly, to a computer and Smartphone application implemented system and method for matching businesses with customers by utilizing an online auction format and limited access to customer contact information.

The present disclosure relates to a method and system for generating business leads, offering said leads to businesses through text message, email and other electronic communications based on lead categories and geographic locations of businesses, customers and potential jobs or goods or services, conducting an online auction for said business lead and delivering complete customer contact information to the business or businesses winning the online auction.

### DISCUSSION OF RELATED ART

Various methods have been employed for matching businesses offering goods or services with consumers seeking such goods or services. One common method for connecting consumers and businesses is for businesses to advertise in print, video or electronic format and wait for potential customers to contact them. In this format business describe the goods and/or services they offer along with their contact information. Customers will then generally contact the business directly by using the contract information provided in the advertisement. In this format, the goods or services offered are described by the business, rather than the customer describing the goods or services they seek. In short, existing advertising procedures are centered on businesses soliciting customers and not customers soliciting businesses.

There exists a need for customers to be able to describe goods or services they seek and allow businesses potentially matching said description to solicit said customers in response to a customer's request in a competitive format without a single customer being bombarded with a litany of offers and solicitations. A simplified, automated, customer and business friendly and time-efficient system is needed for allowing customers to place a request for needed goods or services and have a single or limited number of businesses respond within a limited time period.

### SUMMARY

The method and system described herein may create a user friendly, computer and Smartphone implemented interface for allowing customers to post a request for goods or services, automatically notifying appropriate businesses that can provide the customer with the goods or services requested, generating an online auction for access to the customers complete contact information, conducting an automated online auction where the winning business or a limited number of businesses gain full access to customer's provided contact information (e.g., the business lead) and ultimately allowing businesses to contact the customer to offer the goods or services that the customer requested.

The method and system operate primarily by allowing businesses to sign up for access to potential business leads and an interface where customers can post said leads for goods or services. When a potential customer posts a lead the system will automatically match potential customers with the appropriate businesses based, for example, on defined categories of goods or services identified in the businesses goods or services profile and the geographic area serviced by the business. The system will then conduct an online auction and deliver complete contact information for the potential customer only to the winning business or small group of businesses.

The method and system disclosed herein may operate through interactive features contained on mobile devices or Web based applications and internet/server based web sites.

### BRIEF DESCRIPTION OF THE DRAWINGS

Various illustrative embodiments of the present disclosure are described herein with reference to the drawings, wherein:

FIG. 1 is a flow chart illustrating the steps of an exemplary embodiment of the present invention for matching businesses that provide goods or services with customers requesting such goods or services.

FIG. 2 is a computer system for implementing a method according to an exemplary embodiment of the present invention.

FIG. 3 is an exemplary illustration of a screen shot showing a home page according to an exemplary embodiment of the present invention.

FIG. 4 is an exemplary illustration of a screen shot showing a new account registration page according to an exemplary embodiment of the present invention.

### DETAILED DESCRIPTION

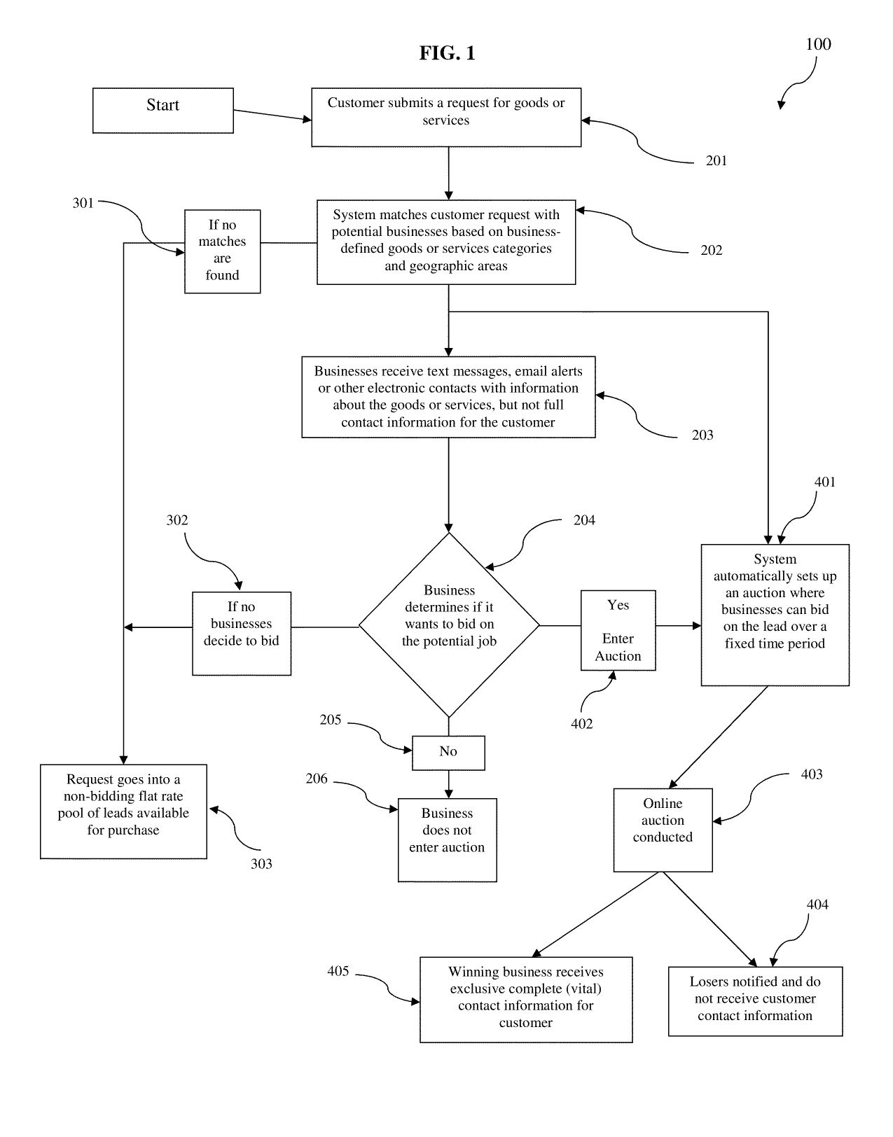

FIG. 1 is a flow chart 100 outlining the steps of an exemplary embodiment of the present invention for matching businesses that provide goods or services with customers requesting such goods or services.

Referring to FIG. 1, step 201 a customer seeking goods or services submits a request for particular goods or services. The customer's request may be completed automatically by the system by selecting tabbed selection criteria, by free form text entry or a combination of the two. The system is designed to be highly flexible to allow customers to describe a wide range of goods or services that the system can recognize and match with potential businesses.

Customer requests may also be sent into the system by phone, email, fax, text message or other similar electronic communication and a human administrator can place a consumer request into the system on consumers' behalf at step 201.

Customers may list goods or services with defined geographic regions attached (e.g. a service area). Such geographic regions may embody the area where goods and services are to be conducted or delivered to. Further, such geographic regions may embody the physical or identified location of the potential businesses who may ultimately deliver goods or services. For example, a service area may be defined as a particularly zip code, town, municipality, county, borough, state, region, country, or the like.

Customers may also identify a time frame for how quickly they will require the goods or services. Some services such as emergency plumbing repair would require businesses to contact the customer within minutes. While in other cases, certain requests for goods or services could wait hours, days, weeks, months or even years.

Customers may also provide such information as a detailed description of goods or service requested, or the position of the customer with regard to the goods or services (e.g., landlord, homeowner, tenant, building manager, or the like). The customer's position may be a professional position with respect to the good or services requested. The customer's position may describe their relationship to the good or services requested. For example, a landlord might request that they be contacted by a handyman capable of completing a requested task on a property the landlord owns. Alternatively, a tenant may request that they be contacted by a handyman to complete a similar task on the same property, however, the tenant may not own the property. The customer's position may be used by the business to determine whether or not to bid for the potential customer's vital contact information.

Referring to FIG. 1, step 202, the system automatically matches a customer's request with a group of businesses that may be able to deliver the requested goods or services. This step can be done rapidly, within seconds, minutes or hours such that the auction described herein can be completed within minutes or hours.

Businesses become eligible for matching a customer's request for goods or services by registering with the system and disclosing the types of goods or services the business offers, as well as the geographic region serviced. This may be completed by selecting tabbed selection criteria from a list, by free form text entry or a combination thereof. Such information becomes part of a business profile and may be used to match the business with requested goods or services.

Businesses may also disclose an amount of time required to complete a particular service or to provide particular goods. For example, a plumber may disclose the amount of time they require to clear a clogged drain or patch a leaking pipe. The amount of time required to complete a service may be used by the system to match a business with a potential customer request, for example, when the potential customer requests that good or services be completed by a desired completion date or time.

Businesses might not be charged a monthly fee to sign up for the system. However, the system is flexible enough to allow a monthly fee to be charged where appropriate, for example in certain areas of goods or services which are highly competitive and may justify businesses paying an up-front cost for access to potential business leads or for scheduling an appointment with a potential customer.

Referring to FIG. 1, step 203, after a customer has posted a request for goods or services, the matched businesses receive text messages, email alerts or other electronic contacts with information about the request and limited information about the potential customer. The electronic communication may invite the business to take part in an auction for the goods or services requested.

At this point, the customer's vital contact information (e.g., information that would allow a business to identify and contact a customer by phone, email or other electronic communication) is kept confidential and is not available to the business. Businesses receive enough general information about the type or category of goods or services requested and the geographic locations identified by the customer to determine whether or not they will enter the auction for the customers complete contact information (the complete business lead).

Businesses are notified of the time that an auction will begin for the complete customer contact information. This time frame is based on the information submitted by the customer in step 201.

Referring to FIG. 1, step 204, each matched business can decide whether or not they wish to enter the auction. If a business elects not to enter the auction 205, then they will not enter the auction and if the business lead proceeds to auction then the business need not receive any additional information.

Referring to FIG. 1, step 301, if no business matches are identified by the system, the system may notify that customer that no matches were immediately identified and the lead may be placed in a fixed rate pool of business leads 303. The system may allow for customers to elect not to have a non-matched lead placed into such a pool.

Where a pool of fixed price leads is generated businesses may have an opportunity to purchase such leads.

The system may match businesses at a later date from the original customer request with customer leads held in the fixed rate pool and notify businesses that matched fixed price leads are available for purchase. That is, the system may suggest to businesses that particular fixed price leads held in the pool may be of interest to the business. As with the auction format, vital customer contact information is kept private until a lead is purchased.

Referring to FIG. 1, step 302, if businesses are matched but no businesses elect to enter the auction then the system will push the lead into the fixed price pool 303 and the related procedures are followed.

Referring to FIG. 1, step 401, after customers and businesses are matched by the system an online auction is automatically generated based on the time frame provided in the customer's request for goods or services.

Businesses deciding to enter the auction 402 may place bids for business leads over a period of time, for example, over a fixed time period. For example, the online auction may be held open for a fixed period of time of approximately 30 minutes.

Referring to FIG. 1, step 403, an online auction is automatically conducted by the system where businesses bid for access to complete customer contact information, which may include customer's phone number, email address, web site, mailing address, social media account information or other similar contact information. The system is flexible to allow new modes of electronic contact information to be accommodated.

The system is typically designed to allow only a single bidding business to gain access to vital customer information by winning the auction. However, the system is also flexible to allow multiple businesses to gain access to vital customer information where a customer requests that multiple businesses may win the auction.

The system is flexible to allow only the winning business or businesses to pay their highest bidding price or to allow businesses to pay for each bid. The specific auction format is determined by the category or type of goods or services, geographic regions or a combination of the two.

The system may also allow customers to request a specific auction format or for businesses to only request notifications about specific auction formats. For example, such an auction format may be an auction with a reserve price or an auction without a reserve price.

The auction may be set at a fixed minimum price at or above $0.00 and this starting bid may be modified by customer request, for example, where appropriate.

Upon completion of the auction, winning businesses receive complete contact information for customers 405, including vital information for contacting the customer. Businesses may be notified by text message, email, phone message or other electronic communication that they have won the auction.

Losing businesses are similarly notified that they have not won the auction 404, but are not given vital contact information for the customer.

Businesses interested in receiving alerts regarding customer requests for information can register with the system by creating an account and registering a credit card with the system. The registered credit card is used to automatically pay for individual bids or for winning bids prior to receiving a complete customer lead with vital contact information. Similarly, businesses can use a registered credit card to pay for fixed price leads from the fixed price lead pool 303.

Business account registration may include providing a plurality of information about the business, including, but not limited to user ID, password, business demographic information, geographic area serviced, types of goods or services offered, number of employees, credentials, certifications, industry accolades or other relevant information.

The system is flexible to allow different categories of information to be entered for either customers or businesses based on individual need, or based on the idiosyncratic attributes unique to individual goods or services.

Customers may place a request with the system by creating a similar user ID or with minimal contact information allowing a business to contact them upon winning a lead at auction or purchasing it from the fixed price pool.

The system is flexible to allow for unlimited new categories of goods or services and any size of geographic area.

The system is flexible to allow for multiple administrator categories ranging from a level one administrator who can change any modifiable aspect of the system or lower level administrators who can, for instance, view all past auctions, view billing information, run sales reports or change level of access for customers or businesses.

It is anticipated that customers may learn of the method and system described herein through various marketing approaches, including print, online, phone, text message and direct marketing and the like. All such marketing approaches may be demographically or geographically targeted.

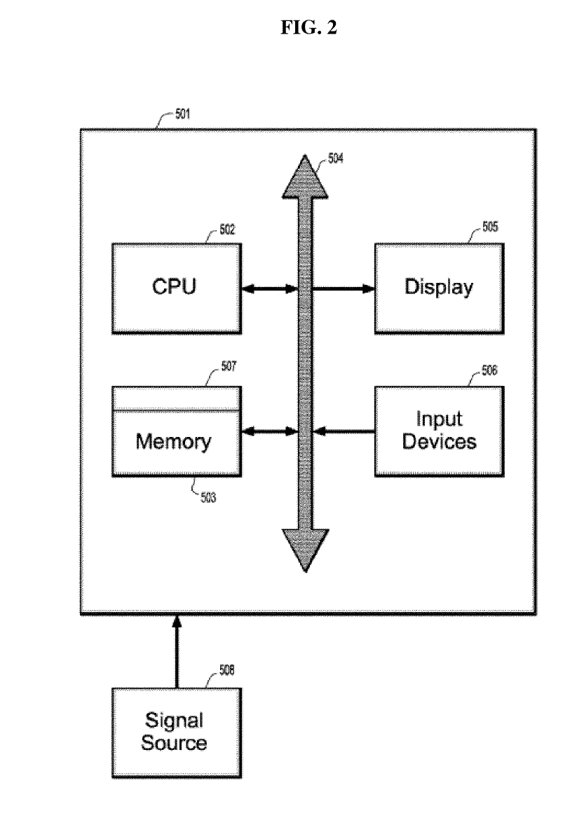

FIG. 2 is a computer system for implementing a method according to an exemplary embodiment of the present invention.

Referring to FIG. 2, according to an exemplary embodiment of the present invention, a computer system 501 for business lead generation and auctioning can comprise, inter alia, a central processing unit (CPU) 502, a memory 503 and an input/output (I/O) interface 504. The computer system 501 is generally coupled through the I/O interface 504 to a display 505 and various input devices 506 such as a mouse and keyboard. The support circuits can include circuits such as cache, power supplies, clock circuits, and a communications bus. The memory 503 can include random access memory (RAM), read only memory (ROM), disk drive, tape drive, etc., or a combination thereofhe present invention can be implemented as a routine 507 stored in memory 503 (e.g., a non-transitory computer-readable storage medium) and executed by the CPU 502 to process the signal from the signal source 508. As such, the computer system 501 is a general-purpose computer system that becomes a specific purpose computer system when executing the routine 507 of the present invention.

The computer platform 501 also includes an operating system and micro-instruction code. The various processes and functions described herein may either be part of the micro-instruction code or part of the application program (or a combination thereof) which is executed via the operating system. In addition, various other peripheral devices may be connected to the computer platform such as an additional data storage device and a printing device.

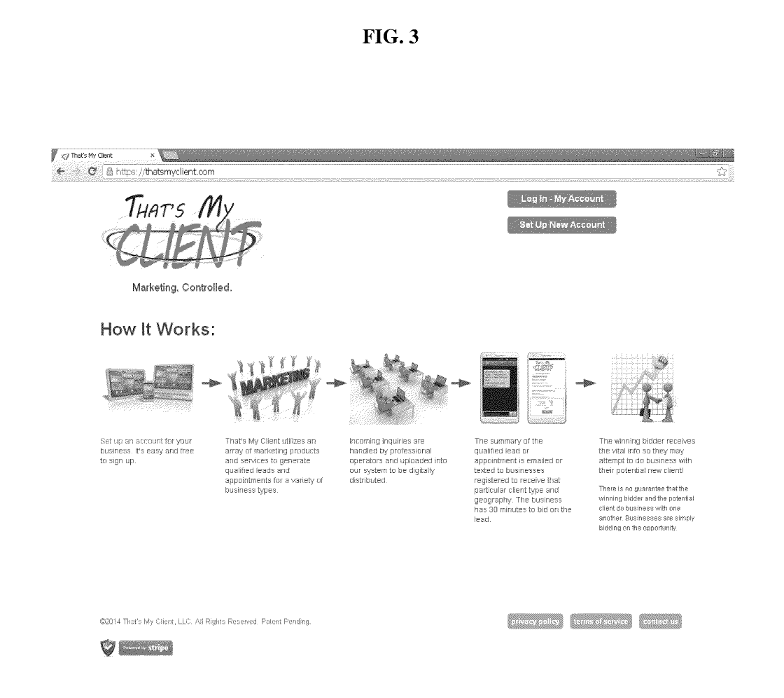

FIG. 3 is an exemplary illustration of a screen shot showing a home page according to an exemplary embodiment of the present invention.

Referring to FIG. 3, according to an exemplary embodiment of the present invention, the system may include an account login and/or a new account registration web page. Marketing products or services may be used to generate qualified leads and appointments for any desired business type.

Inquiries from potential customers (e.g., leads) may be entered manually into the system, or operators may receive leads and input the leads into the system for distribution.

A summary of the qualified lead or appointment may be communicated (e.g., by email or text message) to a business or individual registered to receive the particular client type and geographic range of the lead. The registered business or individual may be given, for example, about 30 minutes notice that an auction will be beginning shortly thereafter.

The winning bidder of the auction may receive the vital contact information for the lead or appointment and may contact the potential new customer using the vital contact information.

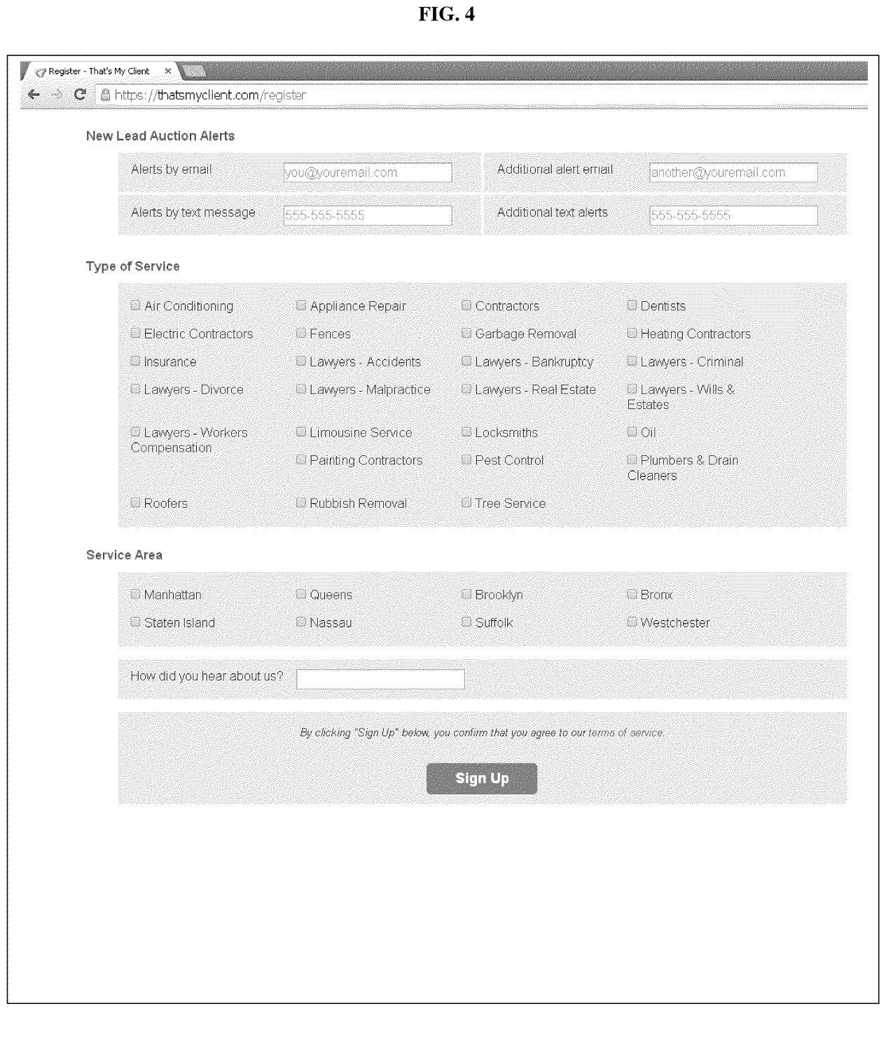

FIG. 4 is an exemplary illustration of a screen shot showing a new account registration page according to an exemplary embodiment of the present invention.

Referring to FIG. 4, according to an exemplary embodiment of the present invention, a new account registration page may allow a new user (e.g., a business or individual service provider) to register for the system by entering an email address and a unique password. The new user may elect to receive new lead auction alerts by one or more email addresses and/or one or more mobile phone numbers, for example.

The new user may select one or more types of services that they can provide. For example, the new user may select “air conditioning” or “appliance repair” as a service that they can provide and would like to receive potential leads for.

The new user may manually enter a type of service that they can provide. The manually entered service may be given a title and/or a more detailed description.

From the foregoing and with reference to the drawings, those skilled in the art will appreciate that certain modifications can also be made to the exemplary embodiments of the present invention without departing from the scope of the same. Therefore, the above descriptions should not be construed as limiting, but merely as exemplifications of particular embodiments.

What is claimed is:

1. A computer-implemented method of business lead auctioning, comprising:
receiving a request for a service from a potential customer;
matching the received request with a plurality of service providers, wherein the request and the plurality of service providers are matched according to a category of the service requested and a geographic area corresponding to the service;
notifying the matched plurality of service providers that a virtual auction will be conducted for a business lead including vital contact information for the potential customer;
generating a virtual auction for the business lead;
conducting the virtual auction, wherein one or more of the matched plurality of service providers bid for access to the vital contact information for the potential customer;
closing the auction; and
providing a winning service provider of the matched plurality of service providers with the vital contact information for the potential customer.

2. The method of claim 1, wherein the virtual auction is conducted for a fixed period of time.

3. The method of claim 1, wherein received requests that are not matched are placed into a flat-rate pool of business leads.

4. The method of claim 1, wherein matched requests that do not receive any business bids are placed into a flat-rate pool of business leads.

5. The method of claim 1, wherein the requested service is selected from a pre-defined service category

6. The method of claim 1, wherein the potential customer enters the service request using free-form text.

7. The method of claim 1, wherein the service request further comprises a requested date of completion for the service requested.

8. The method of claim 1, wherein the potential customer further provides a customer position with respect to the service requested.

9. A computer-implemented method of business lead auctioning, comprising:
receiving a request for goods or services from a potential customer;
matching the received request with a plurality of providers of corresponding goods or services, wherein the request and the plurality of providers are matched;
notifying the matched plurality of service providers that a virtual auction will be conducted for a business lead including vital contact information for the potential customer;
generating a virtual auction for the business lead;
conducting the virtual auction, wherein one or more of the matched plurality of providers bid for access to the vital contact information for the potential customer;
closing the auction; and
providing a winning provider of the matched plurality of service providers with the vital contact information for the potential customer.

10. The method of claim 9, wherein the virtual auction is conducted for a fixed period of time.

11. The method of claim 9, wherein received requests that are not matched are placed into a flat-rate pool of business leads.

12. The method of claim 9, wherein matched requests that do not receive any business bids are placed into a flat-rate pool of business leads.

13. The method of claim 9, wherein the requested service is selected from a pre-defined service category

14. The method of claim 9, wherein the potential customer enters a service request using free-form text.

15. The method of claim 9, wherein the service request further comprises a requested date of completion for the service requested.

16. The method of claim 9, wherein the potential customer further provides a customer position with respect to the service requested.

17. A computer-implemented method of business lead generation, comprising:
receiving a request for a service;
matching the received request with a plurality of service providers, wherein the request and the plurality of service providers are matched according to a category of the service requested and a desired completion date for the service requested;
notifying the matched plurality of service providers that a virtual auction will be conducted for a business lead including vital contact information for the potential customer;
generating a virtual auction for the business lead;
conducting the virtual auction, wherein one or more of the matched plurality of service providers bid for access to the vital contact information for the potential customer;
closing the auction; and
providing a winning service provider of the matched plurality of service providers with the vital contact information for the potential customer.

18. The method of claim 17, wherein the virtual auction is conducted for a fixed period of time.

19. The method of claim 17, wherein received requests that are not matched are placed into a flat-rate pool of business leads.

20. The method of claim 17, wherein matched requests that do not receive any business bids are placed into a flat-rate pool of business leads.
